(19) United States
(12) Patent Application Publication
(10) Pub. No.: US 2011/0111811 A1
(43) Pub. Date: May 12, 2011

(54) MOBILE PHONE POWER SUPPLY CIRCUIT

(75) Inventors: JR-FU JUANG, Tu-Cheng (TW); WEN-CHING HSIAO, Tu-Cheng (TW); WEN-FENG HU, Tu-Cheng (TW); CHUN-LIANG CHEN, Tu-Cheng (TW)

(73) Assignee: HON HAI PRECISION INDUSTRY CO., LTD., Tu-Cheng (TW)

(21) Appl. No.: 12/649,546

(22) Filed: Dec. 30, 2009

(30) Foreign Application Priority Data
Nov. 10, 2009 (CN) 200920314466.3

(51) Int. Cl. H04M 1/00

(52) U.S. Cl. 455/573

(57) ABSTRACT

A mobile phone power supply circuit for a mobile phone, including a super capacitor, a photovoltaic module, a comparator, a battery power source, and a single-pole-double-throw (SPDT) switch. The photovoltaic module buffers solar power in the super capacitor. The comparator compares voltage of the super capacitor and a reference voltage and outputs a control signal according to the comparison. The SPDT switch selects either the super capacitor or the battery power source to supply power to the mobile phone according to the control signal.

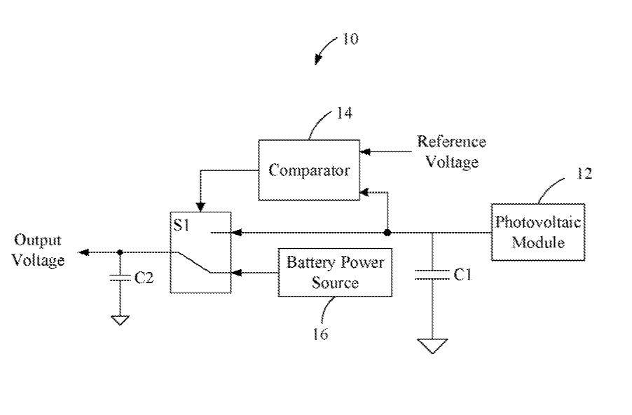

### BACKGROUND

1. Technical Field

Embodiments of the present disclosure relate to power management, and more particularly to a mobile phone power supply circuit.

2. Description of Related Art

Solar power is gaining popularity as an alternative energy source in electronic devices. Most current implementations use photovoltaic cells to charge batteries powering the devices. However, such battery charging wastes a portion of the generated solar power and further requires a large surface area from which the solar energy can be collected.

Since mobile phones are generally required to comply with demands for compact structure, implementation of solar power for charging mobile phone batteries is rarely considered practical. Therefore, a heretofore unaddressed need exists for a mobile phone power supply circuit that can overcome the limitations described.

### BRIEF DESCRIPTION OF THE DRAWINGS

The details of the disclosure, both as to its structure and operation, can best be understood by referring to the accompanying drawings, in which like reference numbers and designations refer to like elements.

The figure is a schematic diagram of one embodiment of a mobile phone power supply circuit of the present disclosure.

### DETAILED DESCRIPTION

The figure is a schematic diagram of one embodiment of a mobile phone power supply circuit 10 of the present disclosure. A chipset in a mobile phone requires at least a system core voltage to make the mobile phone in standby mode, generally between 1.2V and 1.8V, and a working voltage to make the mobile phone in input/output (I/O) mode, generally around 3.3V. In one embodiment, the mobile phone power supply circuit 10 is embedded in the mobile phone and configured and structured to supply the chipset the system core voltage to extend idle time of the mobile phone.

In one embodiment, the mobile phone power supply circuit 10 includes a super capacitor C1, a photovoltaic module 12, a comparator 14, a battery power source 16, a single-pole-double-throw (SPDT) switch S1, and a filtering capacitor C2.

The photovoltaic module 12 is configured and structured to convert solar power into electrical signals to charge the super capacitor C1. In one embodiment, the solar power is gathered by a photovoltaic sensor embedded in a display screen (such as an LCD) of the mobile phone. The photovoltaic module 12 buffers the solar power obtained by the photoelectric board in the super capacitor C1, reducing waste of the solar power. Capacitance of the super capacitor C1 may be predetermined according to the system core voltage required by the chip of the mobile phone and breakdown voltage of the super capacitor C1 must exceed the system core voltage.

The comparator 14 is configured and structured to compare a voltage of the super capacitor C1 and a reference voltage, and output a control signal according to the comparison. In one embodiment, the comparator 14 includes a first input end, a second input end, and an output end. The first input end is configured and structured to input the reference voltage. The second input end is connected to the super capacitor C1 and is configured and structured to input the voltage of the super capacitor C1.

The comparator 14 compares the reference voltage with the voltage of the super capacitor C1 and outputs the control signal accordingly. In one embodiment, the control signal may be a high voltage (such as a logical “1”) or a low voltage (such as a logical “0”). If required, the high voltage may indicate the reference voltage larger than the voltage of the super capacitor C1, and the low voltage may indicate the reference voltage less than or equal to the voltage of the super capacitor C1.

The SPDT switch S1 is configured and structured to select either the super capacitor C1 or the battery power source 16 to supply power to the chip of the mobile phone according to the control signal. A normally closed contact of the SPDT switch S1 is connected to the battery power source 16. A normally open contact of the SPDT switch S1 is connected to the super capacitor C1. A common contact of the SPDT switch S1 outputs the system core voltage to the chip of the mobile phone.

In detail, if the control signal indicates that the voltage of the super capacitor C1 exceeds or equals the reference voltage, that is the voltage of the super capacitor C1 is sufficient to support the chip of the mobile phone in standby mode, the SPDT switch S1 selects the super capacitor C1 to supply power to the chip of the mobile phone. On the contrary, if the control signal indicates that the voltage of the super capacitor C1 is less than the reference voltage, that is the voltage of the super capacitor C1 is insufficient to support the chip of the mobile phone in standby mode, the SPDT switch S1 selects the battery power source 16 to supply power to the chip of the mobile phone.

The filtering capacitor C2 is connected between the output end of the SPDT switch S1 and the ground to filter noisy signals generated by the SPDT switch S1.

In one embodiment, the mobile phone power supply circuit 10 supplies the system core voltage for the chip of the mobile phone. As such, the reference voltage is predetermined as the system core voltage. The capacitance of the super capacitor C1 is also determined according to the system core voltage. In other embodiments, the mobile phone power supply circuit 10 may further be configured and structured to supply the working voltage for the chip of the mobile phone along with development of the super capacitor C1.

The mobile phone power supply circuit 10 of the present disclosure directly powers the mobile phone from the photovoltaic module 12 if the voltage of the super capacitor C1 exceeds or equals the reference voltage and powers the mobile phone from the battery power source 16 if the voltage of the super capacitor C1 is less than the reference voltage, which improves utilization of the solar power. Thus, the mobile phone power supply circuit 10 not only supplies power to the mobile phone using the solar power, but also automatically sources supply power from the battery power source 16 if the solar power is insufficient.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A power supply circuit for a mobile phone, the power supply circuit comprising:
a battery power source;
a super capacitor;
a photovoltaic module configured and structured to convert solar power into electrical signals to charge the super capacitor;
a comparator configured and structured to compare a voltage of the super capacitor and a reference voltage, and output a control signal according to the comparison; and
a single-pole-double-throw (SPDT) switch configured and structured to select either the super capacitor or the battery power source to supply power to the mobile phone according to the control signal;
wherein the SPDT switch selects the super capacitor to supply power to the mobile phone if the voltage of the super capacitor exceeds or equals the reference voltage, and selects the battery power source to supply power to the mobile phone if the voltage of the super capacitor is less than the reference voltage.

2. The mobile phone power supply circuit as claimed in claim 1, wherein the SPDT switch selects either the super capacitor or the battery power source to supply a system core voltage of the mobile phone.

3. The mobile phone power supply circuit as claimed in claim 2, wherein the reference voltage is predetermined as the system core voltage of the mobile phone.

4. The mobile phone power supply circuit as claimed in claim 1, further comprising a filtering capacitor connected between an output end of the SPDT switch and the ground to filter noise generated by the SPDT switch.
